(19) United States
(12) Patent Application Publication
(10) Pub. No.: US 2006/0144891 A1
(43) Pub. Date: Jul. 6, 2006

(54) Rechargeable powered stapler assembly

(75) Inventor: David P. Adams, Barrington, IL (US)

Correspondence Address: MICHAEL BEST & FRIEDRICH, LLP, 100 E WISCONSIN AVENUE, MILWAUKEE, WI, 53202, US

(73) Assignee: ACCO Brands, Inc., Lincolnshire, IL (US)

(21) Appl. No.: 11/028,164

(22) Filed: Jan. 3, 2005

(51) Int. Cl. B25C 5/02

(52) U.S. Cl. 227/131; 173/1

(57) ABSTRACT

A stapler assembly includes a base and a stapler coupled to the base. An inductive power supply system cooperates between the base and the stapler to supply power from the base to the stapler. The stapler can be movable with respect to the base between a first position, wherein the stapler has a first orientation with respect to the base, and a second position, wherein the stapler has a second orientation with respect to the base. The base preferably includes a holster configured to receive the stapler. The holster is pivotable to move the stapler between the first and second positions. The inductive power supply system eliminates the need for physical electrical connections between the stapler and the base.

### FIELD OF THE INVENTION

The invention relates to staplers, and more particularly to powered staplers.

### BACKGROUND OF THE INVENTION

Powered staplers are well known and allow a user to staple sheets without any significant manual input of force to the stapler. The user simply inserts the sheets to be stapled between the magazine and the anvil, and a staple is automatically, or at the press of a button, dispensed to fasten the sheets together. Electric staplers are typically powered by an AC to DC current supply, and thus are plugged into an outlet near the user's workspace. The stapler commonly rests on the user's desktop or countertop such that the magazine and the anvil are spaced apart vertically to define a substantially horizontal sheet infeed slot. Sheets to be stapled are inserted into the slot in a substantially horizontal direction.

### SUMMARY OF THE INVENTION

The invention provides a stapler assembly including a base, a stapler removably coupled to the base, and an inductive power supply system cooperating between the base and the stapler to supply power from the base to the stapler. In one embodiment, the base includes a charging unit having a first coil, and the stapler includes a second coil. Power supplied to the first coil in the base induces a current in the second coil in the stapler. The current in the second coil is operable to charge a battery unit in the stapler.

In one aspect of the invention, the stapler is movable with respect to the base between a first position, wherein the stapler has a first orientation with respect to the base, and a second position, wherein the stapler has a second orientation with respect to the base. The inductive charging system facilitates the relative movement between the stapler and the base because there need not be any physical electrical connection between the base and the stapler.

Other features and advantages of the invention will become apparent to those skilled in the art upon review of the following detailed description, claims, and drawings.

### BRIEF DESCRIPTION OF THE DRAWINGS

FIG. 1 is a perspective view of a stapler assembly.

FIG. 2 is a side view of the stapler assembly of FIG. 1, shown in a first position.

FIG. 3 is a side view of the stapler assembly of FIG. 1, shown in second and third positions.

FIG. 4 is a partial side view showing the stapler removed from the base assembly.

FIG. 5 is an enlarged side view with the base assembly shown in section.

FIG. 6 is a section view taken along line 6-6 in FIG. 5, shown with the stapler removed.

FIG. 7 is an enlarged side view of another stapler assembly incorporating an inductive battery charging system.

FIG. 8 is an enlarged side view of another stapler assembly, similar to that shown in FIG. 7, with the primary coil of the inductive battery charging system housed in an alternative location.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including”, “having” and “comprising” and variations thereof herein is meant to encompass the items listed thereafter and equivalents thereof as well as additional items.

### DETAILED DESCRIPTION

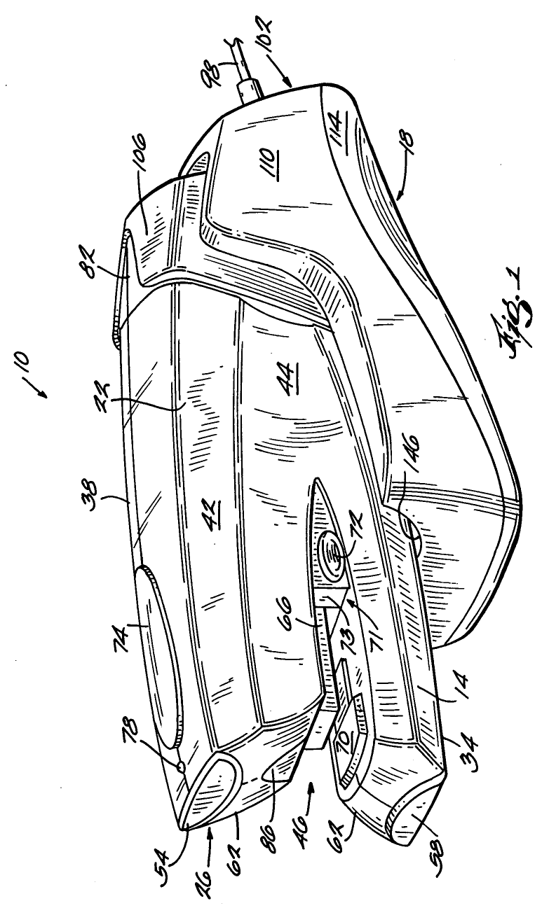

FIGS. 1-6 illustrate a stapler assembly 10. The stapler assembly 10 includes a stapler 14 and a base assembly 18 configured to receive the stapler 14. In the illustrated embodiment, the stapler 14 is an electric stapler having a body portion 22. The body portion 22 includes a front end 26, a rear end 30, a bottom surface 34, a top surface 38, and opposing side surfaces 42. Each side surface 42 defines a side recess 44. As used herein and in the appended claims, the terms front, rear, bottom, top, upper, and lower are used for the purpose of illustration only, and are not intended to imply any particular orientation.

The body portion 22 is configured to define an infeed slot 46 adjacent the front end 26. The infeed slot 46 defines an infeed axis 50 that is substantially parallel to the longitudinal axis of the stapler 14. The infeed slot 46 divides the front end 26 of the stapler 14 into an upper nose portion 54 and a lower nose portion 58. The nose portions 54 and 58 preferably include tapered surfaces 62 to facilitate insertion of a plurality of sheets (not shown) into the infeed slot 46 for stapling.

A magazine 66 is coupled to the upper nose portion 54 adjacent a first side of the infeed slot 46, and an anvil 70 is coupled to the lower nose portion 58 adjacent a second side of the infeed slot 46. The magazine 66 includes an opening (not shown) for dispensing a staple (not shown) through a plurality of sheets positioned in the infeed slot 46. When the legs of the staple contact the anvil 70 they are bent and crimped, thereby fastening the sheets in a manner understood by those skilled in the art.

The stapler 14 also includes a paper guide mechanism 71 slidably positioned in the infeed slot 46. The paper guide mechanism 71 includes opposing projections 72 that facilitate the user grasping the paper guide mechanism 71 and sliding the paper guide mechanism 71 back and forth in the direction of the infeed axis 50. As is understood by those skilled in the art, the paper guide mechanism 71 functions to adjustably limit the effective length of the infeed slot 46 so that the staple is dispensed at the desired location relative to the plurality of sheets being stapled.

The paper guide mechanism 71 includes a wall or spring-tab 73 (see FIG. 1) configured to automatically actuate the dispensing of a staple. In the illustrated embodiment, the wall 73 is spring-loaded such that when sheets of paper being inserted into the infeed slot 46 contact the wall 73, the wall 73 is deflected toward the rear end 30 of the stapler 14. This deflection actuates the dispensing of a staple in a known manner. Of course other types of proximity sensors or vision sensors can also be used to automatically actuate stapling. Alternatively, the stapler 14 could include a manual push-button to activate stapling.

The stapler 14 further includes a logo portion 74 and a low staple indicator 78 in the form of a light bulb or LED on the top surface 38. In the illustrated embodiment, the low staple indicator 78 is illuminated when the supply of staples in the magazine 66 falls below a predetermined number (e.g., ten staples). Of course, the location of the logo portion 74 and the indicator 78 can vary as desired.

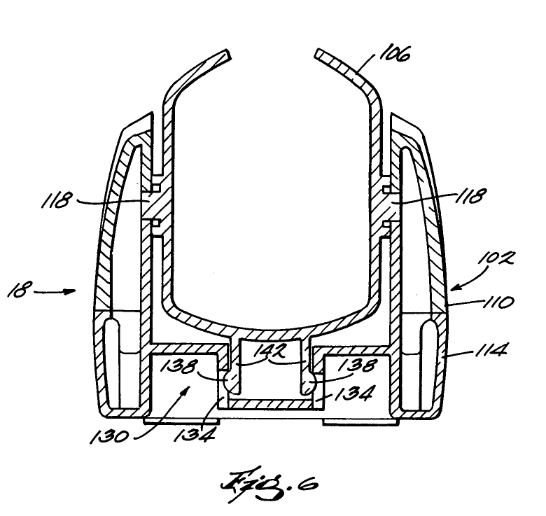

The magazine 66 is slidably coupled to a cartridge assembly (not shown) so that the magazine 66 can be opened via a magazine release button 82 (see FIGS. 4 and 5) near the rear end 30 of the stapler 14. When the button 82 is depressed, the magazine 66 slides out from the front end 26 and can be loaded with staples. A grip portion 86 facilitates opening and closing the magazine 66. The rear end 30 also includes an electrical socket 90 configured to receive a mating electrical connector. As will be described in greater detail below, the electrical socket 90 is configured to receive an electrical connector 94 of a power supply cord 98 (see FIG. 4), or an electrical connector that is coupled to the base assembly 18.

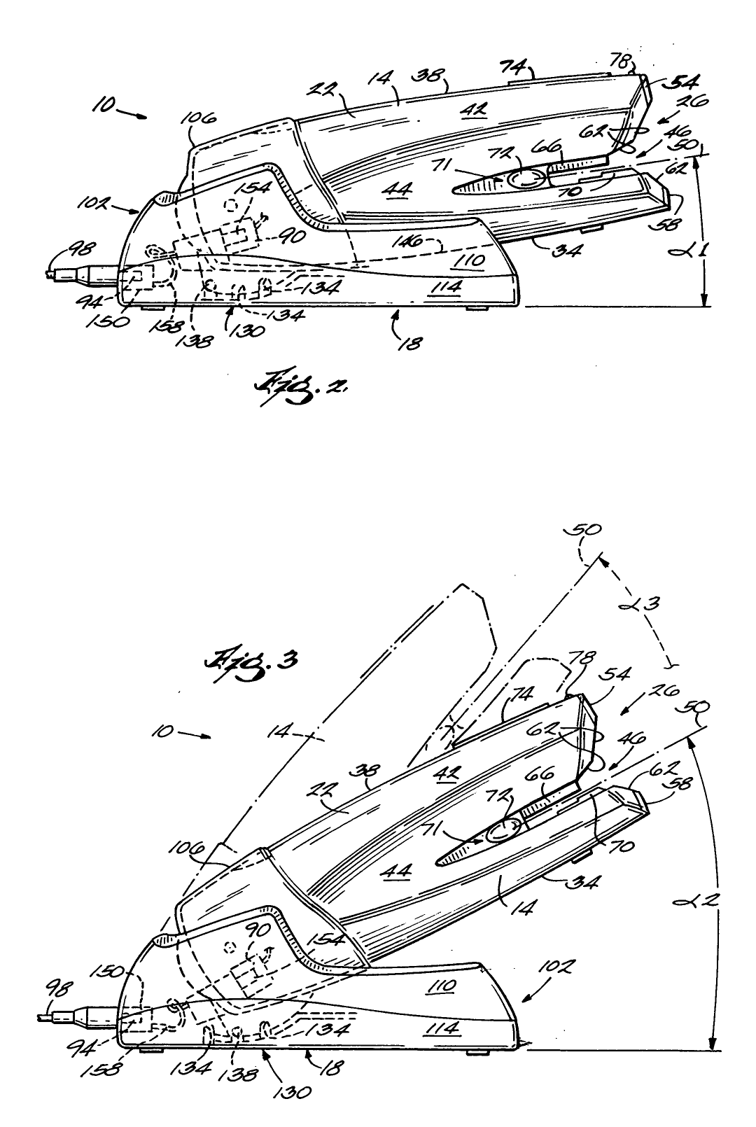

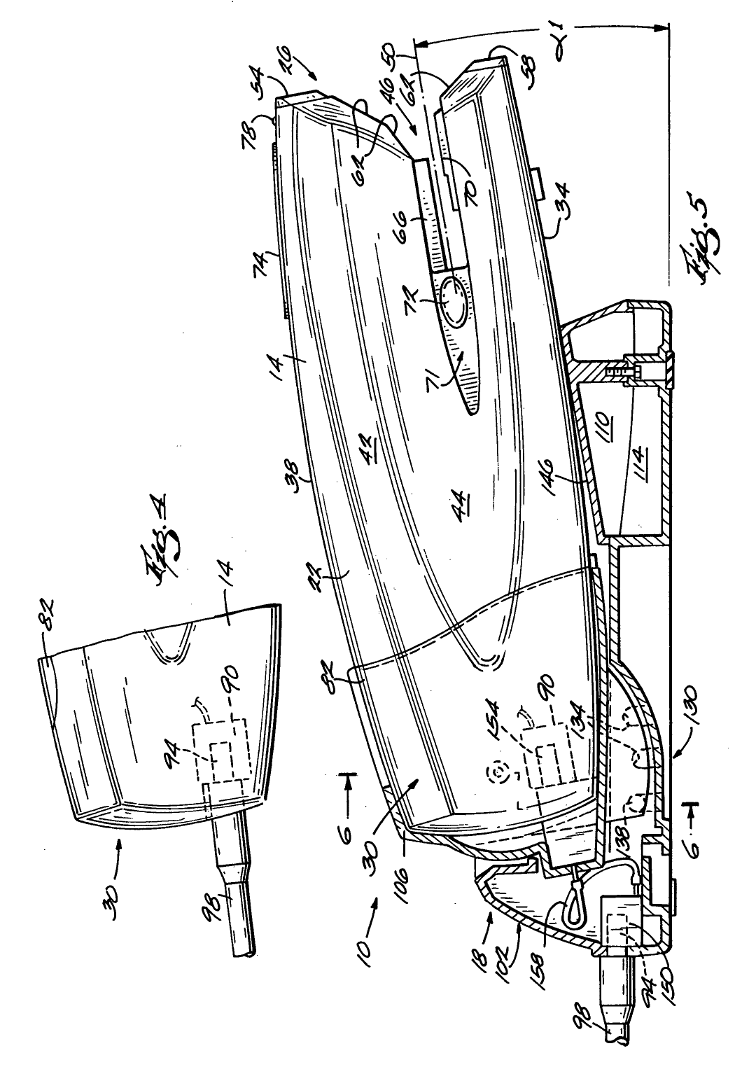

The base assembly 18 is configured to removably receive and support the stapler 14 in a plurality of predetermined positions (see FIGS. 2 and 3). In the illustrated embodiment, the base assembly 18 includes a cradle 102 and a holster 106 pivotally mounted to the cradle 102. The holster 106 can be moved relative to the cradle 102 so that the stapler 14 can be quickly and easily moved between a plurality of angled stapling positions relative to the base assembly 18.

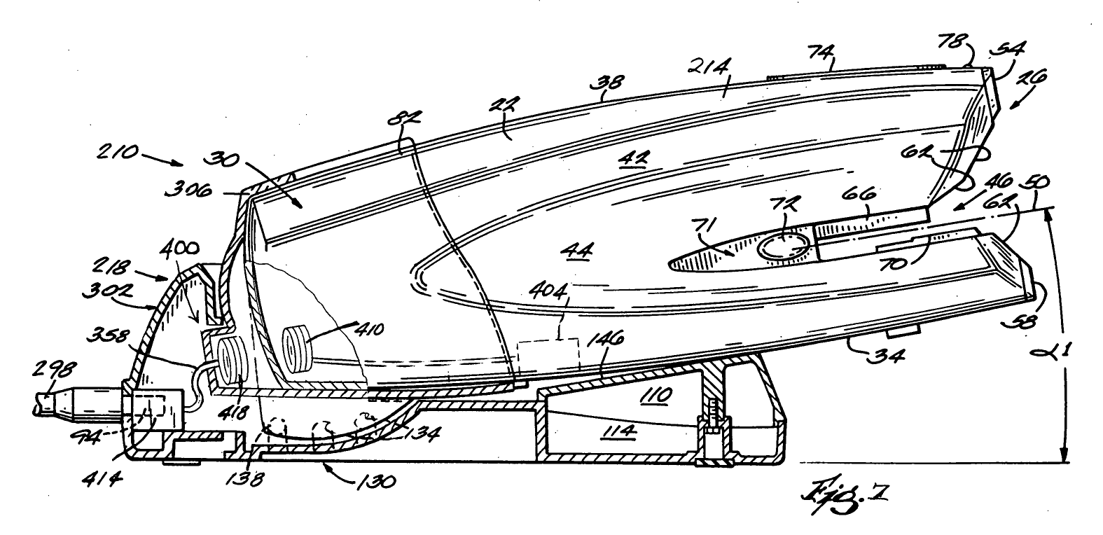

The cradle 102 is preferably a two-piece part defined by an upper half 110 and a lower half 114. In the illustrated embodiment, the cradle is a molded plastic part. The holster 106 is configured to receive the rear end 30 of the stapler 14 and is pivotally coupled to the cradle 102 to pivot about projections 118 (see FIG. 6) extending outwardly from either side of the holster 106. In the illustrated embodiment, the holster 106 is also a molded plastic part, and the pivot projections 118 are sandwiched or retained between the upper half 110 and the lower half 114 of the cradle 102.

One of ordinary skill in the art would understand that the pivotable mounting of the holster 106 in the cradle 102 could be achieved in various other ways without departing from the scope of the invention. In addition, other types of structures incorporating other forms of movement could also be employed. For example, ball-and-socket configurations or curvilinear tongue-and-groove configurations could be used to generate the relative movement between the holster 106 and the cradle 102. Furthermore, other materials, such as metals, could be substituted for the cradle 102 and the holster 106.

Referring to FIGS. 2-6, the base assembly 18 further includes a detent mechanism 130 cooperating between the cradle 102 and the holster 106 to provide a plurality of predetermined and substantially secured pivot positions for the holster 106 and the stapler 14. In the illustrated embodiment, the detent mechanism 130 includes three pair of spaced-apart recesses or detents 134 formed in the lower half 114 of the cradle 102, and a pair of spaced-apart projections 138 that extend from respective extensions 142 (see FIG. 6) on the underside of the holster 106.

FIGS. 1, 2, and 5 illustrate the holster 106 and stapler 14 pivoted to a first position or orientation with respect to the cradle 102. In this first position, the projection 138 is located in the recess 134 furthest to the left, as viewed in FIGS. 2 and 5. When the stapler 14 and the holster 106 are in the first position, at least a portion of the bottom surface 34 of the stapler 14 rests on and is supported by a support tray 146 defined by the upper half 110 of the cradle. The infeed axis 50 is oriented at a first incline angle α1 with respect to the bottom surface of the cradle 102. In the illustrated embodiment, the incline angle α1 is approximately ten degrees, however other angles can be substituted. The first position may facilitate stapling for a shorter user standing adjacent a desk or for a user who is sitting at a desk.

Depending on the location of the stapler assembly 10 and the position/height of the user, stapling may be facilitated by pivoting the holster 106 an therefore the stapler 14, to a second position or orientation, wherein the infeed slot 46 is oriented differently with respect to the cradle 102. The solid line rendition in FIG. 3 illustrates the holster 106 and stapler 14 in a second position with respect to the cradle 102. In this second position, the projection 138 is located in the middle recess 134, as viewed in FIG. 3. When the stapler 14 and the holster 106 are in the second position, the bottom surface 34 of the stapler 14 is no longer supported by the support tray 146. The infeed axis 50 is oriented at a second, steeper incline angle α2 with respect to the bottom surface of the cradle 102. In the illustrated embodiment, the incline angle α2 is approximately twenty-seven and one-half degrees; seventeen and one-half degrees steeper than the incline angle α1. The second position may facilitate stapling for a taller user standing or sitting near the stapler assembly 10.

Pivoting the stapler from the first position to the second position is done manually in the illustrated embodiment. The user grasps the stapler 14 while it is engaged in the holster 106 and then moves the stapler 14 toward the second position. With sufficient force, the somewhat resilient projections 138 disengage from their respective first position recesses 134 (the left-most recess in FIGS. 2 and 3) and move toward the second position recesses 134 (the middle recess in FIGS. 2 and 3) until the projections 138 snap into the middle recesses 134, thereby substantially securing the holster 106 in the second position.

In this manner, the stapler 14 and holster 106 can be quickly moved between the illustrated stapling positions between consecutive stapling jobs. Of course, the holster 106 can also be pivoted between the various positions when the stapler 14 is removed from the holster 106, however, pivoting the holster 106 using the inserted stapler 14 facilitates the task due to the mechanical lever-type advantage gained by exerting force on the front end 26 of the stapler 14, a greater distance away from the pivot point.

Any number of positions can be achieved depending on the number of recesses 134 in the cradle 102. For example, FIG. 3 shows a third position (shown in phantom) in which the stapler 14 is pivoted such that the infeed axis 50 forms an even steeper, third incline angle α3 with respect to the bottom surface of the cradle 102. In the illustrated embodiment, the incline angle α3 is approximately forty-five degrees; thirty-five degrees steeper than the incline angle α1. In this third position, the projection 138 is located in the recess 134 furthest to the right, as viewed in FIG. 3. The third position may facilitate stapling for a taller user standing close to or directly over the stapler assembly 10.

It is to be understood that while the base assembly 18 is shown with the cradle 102 oriented to be supported by a substantially horizontal support surface (not shown), the cradle 102 could alternatively be coupled to an inclined surface or a substantially vertical support surface (such as a wall or other vertical member), wherein the base assembly 18 shown in FIGS. 2 and 3 would be rotated approximately ninety degrees in a counter-clockwise direction. In the same manner described above, the stapler 14 could be pivoted between the three illustrated positions as desired to facilitate stapling.

Furthermore, one of skill in the art would recognize that the particular structure of the illustrated detent mechanism 130 could be modified without deviating from the invention. For example, the position of the recesses 134 and the projections 138 could be reversed. In addition, the location of the detent mechanism 130 could be moved from the underside of the holster 106 (as shown in FIG. 6) to either or both sides of the holster 106. The detent mechanism 130 could also be modified to change the illustrated incline angles to any desired angles.

Alternatively, the detent mechanism 130 could be replaced with other types of devices capable of substantially locking the holster 106 in a selected position with respect to the cradle 102. For example, friction locking mechanisms (e.g., set screws or spring-loaded pins) or positive locking mechanisms (e.g., bolts and wingnuts or spring-ball-loaded pushpins) could be used to allow for adjustment between desired positions.

In another alternative, the holster 106 and the cradle 102 can be assembled with a friction-fit such that the friction present between the holster 106 and the cradle 102 can be overcome by manually-applied force to set the position of the holster 106. Once the position is set, the friction force is sufficient to hold the holster 106 and the stapler 14 in the desired position. It is also understood that these alternatives could provide for more infinite adjustment of the holster 106. In other words, the number of possible position settings could be virtually infinite as opposed to the three distinct position settings shown in the illustrated embodiment.

As mentioned above, the illustrated stapler 14 is electrically powered, and therefore requires electrical power from a power supply (an AC current supply in the illustrated embodiment). In FIG. 4, the stapler is shown removed from the base assembly 18 and the electrical connector 94 of the power supply cord 98 is plugged directly into the rear end 30 of the stapler 14. When it is desired to couple the stapler 14 to the base assembly 18 by inserting the rear end 30 of the stapler 14 into the holster 106, the user first unplugs the power supply cord 98 from the stapler 14 and plugs the electrical connector 94 into a socket 150 housed in the base assembly 18. In the illustrated embodiment, the socket 150 is housed in the cradle 102.

The base assembly 18 is provided with an electrical connector 154 that is substantially similar to the electrical connector 94. In the illustrated embodiment, the electrical connector 154 is coupled to the holster 106 and extends into the stapler-receiving cavity defined by the holster 106. As the rear end 30 of the stapler 14 is inserted into the holster 106, the connector 154 is automatically and substantially simultaneously inserted into the socket 90 in the rear end 30 of the stapler 14. To electrically connect the socket 150 to the electrical connector 154 in the holster 106, a flexible conductor in the form of a wire 158 is coupled between the socket 150 and the electrical connector 154. The wire 158 is long enough and flexible enough to allow the electrical connection between the cradle 102 and the holster 106 to be maintained throughout the range of relative motion between the holster 106 and the cradle 102.

When the stapler 14 is removed from the holster 106, the electrical connector 154 automatically disengages the socket 90 in the stapler 14. To use the stapler 14 without the base assembly 18, the user unplugs the power supply cord 98 from the cradle 102 and plugs the electrical connector 94 directly into the socket 90 in the stapler 14. Alternatively, two separate power cords 98 can be used such that the base assembly 18 will always remain plugged-in. The second cord 98 can be used specifically for when the stapler 14 is disengaged from the base assembly 18.

In addition to the friction fit between the rear end 30 of the stapler 14 and the inner wall of the holster 106, the electrical connector 154 also helps to secure the stapler 14 in the holster 106. One skilled in the art would also recognize additional ways to help secure the stapler 14 in the holster 106. For example, the sidewalls of the holster 106 could be contoured to more closely follow the contours of the side surfaces 42 and could include curved portions configured to engage the side recesses 44. In one embodiment, the sidewalls of the holster 106 could include inwardly biased, resilient curved portions that engage the side recesses 44 and squeeze the stapler 14. Detent mechanisms could also be used to help secure the stapler 14 in the holster 106.

It should be understood that the illustrated electrical components and their respective locations can be modified by those skilled in the art. For example, instead of the illustrated electrical connectors, conductive contacts or other similar components can be used. In addition to providing direct electrical power in the form of AC current to the stapler 14, the base assembly 18 could also function as a charging stand for rechargeable, battery-powered (DC current) staplers. While not shown, the stapler 14 could include a rechargeable battery unit that would permit operating the stapler 14 in a cordless manner, in addition to use with the power supply cord 98. To recharge the battery, the stapler could be stored in the holster 106 such that the electricity provided via the electrical connector 154 would recharge the battery unit in the stapler.

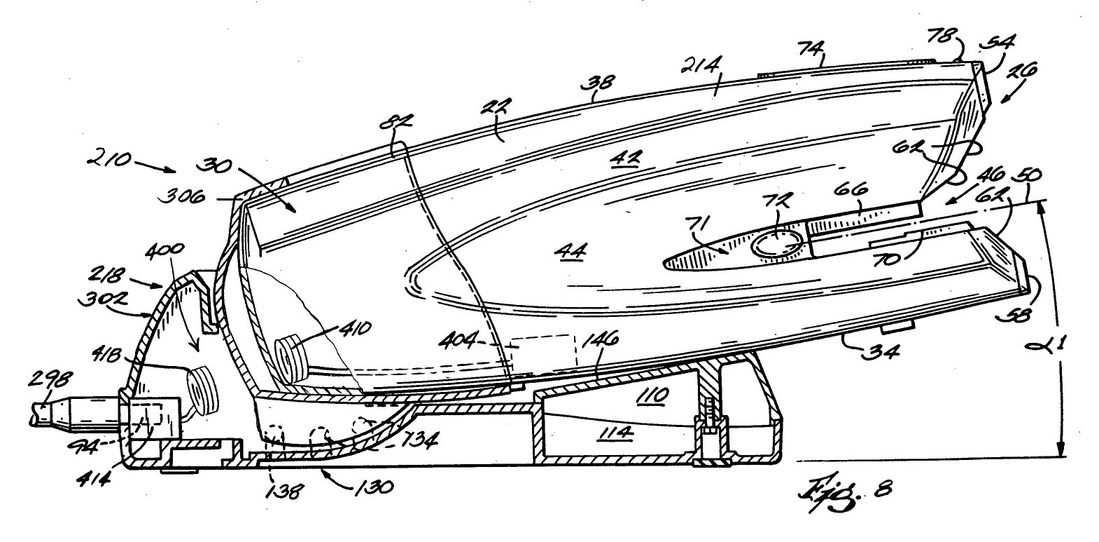

FIG. 7 illustrates another stapler assembly 210. The stapler assembly 210 of FIG. 7 is substantially the same as the stapler assembly 10 of FIGS. 1-6 and like parts have been given like reference numerals. The difference between the stapler assembly 210 of FIG. 7 and the stapler assembly 10 of FIGS. 1-6 relates to the configuration of the power supply, and more specifically to the provision of an inductive power supply system 400.

Specifically, the stapler assembly 210 of FIG. 7 includes a stapler 214 that is powered by a DC battery unit 404. As illustrated in FIG. 7, the battery unit 404 is rechargeable and is electrically connected to a pick-up coil 410 positioned closely adjacent the rear end 30 of the stapler 214. The pick-up coil 410 is illustrated as being a coil of wire, however the pick-up coil 410 could alternatively be of other suitable constructions. For example, the pick-up coil 410 could take the form of an etched rigid or flexible circuit board configured in an inductive pattern or other appropriate configuration. The pick-up coil 410 could also take the form of a strands of wire braided together, copper braid, or a molded interconnect type of device that would be a plated-on type of inductor.

The base assembly 218 includes a charging unit 414 that receives electrical power from a power supply (an AC to DC power supply in the illustrated embodiment). A power cord 298 provides power to the charging unit 414 in the illustrated embodiment. The charging unit 414 includes a primary or charging coil 418 positioned within the base assembly 218 in a location closely adjacent to the pick-up coil 410 in the rear end 30 of the stapler 218. The primary coil 418 is illustrated as being a coil of wire, however the primary coil 418 could alternatively be of other suitable constructions, including those described above with respect to the pick-up coil 410.

As shown in FIG. 7, the primary coil 418 is housed in the holster 306. A flexible lead 358 electrically connects the charging unit 414 to the primary coil 418. In another embodiment illustrated in FIG. 8, the primary coil 418 can be housed in the cradle 302. In either case, when the stapler 214 is supported by the base assembly 218, the two coils 410 and 418 remain closely adjacent regardless of the relative positioning of the stapler 214 with respect to the base assembly 218. This ensures that the inductive circuit formed between the coils 410 and 418 will operate when the stapler assembly 210 is oriented in any of the orientations shown in FIGS. 2 and 3 with respect to the stapler assembly 10. The inductive circuit will also remain operable during movement between any of the positions illustrated in FIGS. 2 and 3.

The primary coil 418, when energized, has current running through it, which creates magnetic flux lines. The flux lines induce a current in the pick-up coil 410. The current in the pick-up coil 410 is then used to charge the battery unit 404 in a known manner. Those skilled in the art will understand that the inductive power supply system 400 can be configured in numerous ways to achieve the desired battery charging capabilities. For example, a suitable rectifier circuit (not shown) can be used to rectify the current induced in the pick-up coil 410. Additionally, protective devices (e.g., thermal shutdown devices, fuses, etc.) can be used with the inductive power supply system 400. Furthermore, the pick-up coil 410 and primary coil 418 can be shielded to prevent induction of current into other portions of the stapler 214.

The inductive power supply system 400 is well-suited for use with the stapler assembly 210, as it eliminates the need for a physical, electrical connection (e.g., a hardwired connection) between the base assembly 218 and the stapler 214. Instead, the induction of current from the primary coil 418 in the base assembly 218 to the pick-up coil 410 in the stapler 214 occurs without any physical, electrical connection between the base assembly 218 and the stapler 214. This is particularly advantageous due to the relative movement that can occur between the stapler 214 and the base assembly 218, as described above with respect to the stapler assembly 10 of FIGS. 1-6. In the event the primary coil 418 is housed in the cradle 302, as illustrated in FIG. 8, the electrical configuration of the stapler assembly 210 is further simplified in that no electrical components (e.g., wiring, etc.) need bridge the movable interface between the cradle 302 and the holster 306 of the base assembly 218.

While FIGS. 7 and 8 clearly illustrate the inductive power supply system 400 in the stapler assembly 210, it is to be understood that the inductive power supply system 400 could also be combined with the power supply system illustrated in the stapler assembly 10 of FIGS. 1-6.

Various features of the invention are set forth in the following claims.

1. A stapler assembly comprising:
a base;
a stapler removably coupled to the base; and
an inductive power supply system cooperating between the base and the stapler to supply power from the base to the stapler.

2. The stapler assembly of claim 1, wherein the inductive power supply system supplies power from the base to the stapler without any physical electrical connection between the base and the stapler.

3. The stapler assembly of claim 1, wherein the base includes a charging unit having a first coil, wherein the stapler includes a second coil, and wherein power supplied to the first coil in the base induces a current in the second coil in the stapler.

4. The stapler assembly of claim 3, wherein the stapler further includes a rechargeable battery unit and wherein the current in the second coil is operable to charge the battery unit.

5. The stapler assembly of claim 3, wherein the base includes a cradle and a holster supported by the cradle, and wherein the first coil is in one of the cradle and the holster.

6. The stapler assembly of claim 5, wherein the first coil is in the cradle.

7. The stapler assembly of claim 5, wherein the first coil is in the holster.

8. The stapler assembly of claim 5, wherein the holster receives a rear end of the stapler, and wherein the second coil is in the rear end of the stapler.

9. The stapler assembly of claim 5, wherein the holster is movable with respect to the cradle.

10. The stapler assembly of claim 9, wherein the holster is pivotable with respect to the cradle.

11. The stapler assembly of claim 1, wherein when the stapler is coupled to the base, the stapler is movable with respect to the base between a first position, wherein the stapler has a first orientation with respect to the base, and a second position, wherein the stapler has a second orientation with respect to the base.

12. The stapler assembly of claim 11, wherein the base includes a holster configured to receive the stapler, and wherein the holster is movable with respect to a remainder of the base to move the stapler between the first and second positions.

13. The stapler assembly of claim 12, wherein the base includes a charging unit having a first coil, wherein the stapler includes a second coil in the portion of the stapler received by the holster, and wherein power supplied to the first coil in the base induces a current in the second coil in the stapler.

14. The stapler assembly of claim 13, wherein the first and second coils are closely adjacent one another when the stapler is in each of the first and second positions and when the stapler is moved between the first and second positions.

15. The stapler assembly of claim 13, wherein the stapler further includes a rechargeable battery unit and wherein the current in the second coil is operable to charge the battery unit.

16. A method of powering a stapler assembly including a base and a stapler removably coupled to the base, the method comprising:
providing a charging unit in the base, the charging unit including a first coil;
providing a battery unit in the stapler, the battery unit being electrically connected to a second coil in the stapler; and
supplying power to the first coil in the base to induce a current in the second coil that charges the battery unit in the stapler.

17. The method of claim 16, wherein the stapler is movable with respect to the base between first and second stapling positions, and wherein supplying power to the first coil induces a current in the second coil when the stapler is in either of the first or second stapling positions.

18. The method of claim 16, wherein the base includes a cradle and a holster supported by the cradle, the holster being movable with respect to the cradle and configured to receive the stapler, and wherein providing a charging unit in the base includes positioning the first coil in the cradle.

19. The method of claim 16, wherein the base includes a cradle and a holster supported by the cradle, the holster being movable with respect to the cradle and configured to receive the stapler, and wherein providing a charging unit in the base includes positioning the first coil in the holster.

20. The method of claim 16, wherein the induction of current in the second coil is achieved without any physical electrical connection between the base and the stapler.
